(19) United States
(12) Patent Application Publication
(10) Pub. No.: US 2008/0255866 A1
(43) Pub. Date: Oct. 16, 2008

(54) Systems and methods to integrated business data

(76) Inventor: Jan Matthes, Hessen (DE)

Correspondence Address: SAP AG c/o BUCKLEY, MASCHOFF & TALWALKAR LLC, 50 LOCUST AVENUE, NEW CANAAN, CT, 06840, US

(21) Appl. No.: 11/784,915

(22) Filed: Apr. 10, 2007

(51) Int. Cl. G06Q 10/00

(52) U.S. Cl. 705/1

(57) ABSTRACT

According to some embodiments, a selection of source data elements may be received via an enterprise resource planning user interface. The source data elements may be associated with, for example, a first planning integration area. A selection of result data elements may also be received via the enterprise resource planning user interface, and the result data elements may be associated with a second planning integration area. It may then be arranged for information to be automatically transferred from the selected source data elements of the first planning integration area to the result data elements of the second planning integration area.

### FIELD

Some embodiments of the present invention may relate to business information enterprise systems. In particular, some embodiments may be associated with systems and methods to facilitate integration of business plan data.

### BACKGROUND

A business information enterprise system may improve an organization's ability to monitor and/or manage data in a complex business environment. For example, such a system might store a large amount of plan information, including yearly global sales plan and profitability plan figures on both a company-wide and regional basis. Different users may then access the information in different ways. For example, a first user might be interested in a normalized comparison of each year's sales plan figures as compared to other years. Another user might instead want to use current and historical sales figures on a region-by-region basis to plan future profitability. In general, many different types of data could be stored by, and accessed from, a business information enterprise system (e.g., inventory data, product demand data, and/or accounting data) and different types of data can often be used in different ways.

Note that a user might want to incorporate plan data from one area of a business information enterprise system (e.g., sale plans) into another area of the system (e.g., demand or profitability plans). For example, current and/or predicted sales information might be used to generate and/or update a profitability plan for an enterprise. In some cases, a user might manually enter data he or she reads from one area of the system into another area. This approach, however, can be a difficult and time consuming process, especially when many data sources and/or destinations are involved. Moreover, such an approach could lead to errors if a user incorrectly enters wrong information.

A user may instead copy data from one area of the business information enterprise system into another area of the system. The use of this type of approach, however, could be limiting. For example, such a cut-and-paste technique might only let a user copy a single data value from one area to another area. Moreover, a simple copy of data from one place to another might not accurately reflect the information that is required in different areas.

Approaches that may improve a user's ability to use information one area of a business information enterprise system in other areas of the system could, therefore, be desirable. Moreover, it may advantageous to provide one or more tools that facilitate a user's ability to do so in a relatively timely and productive manner.

### BRIEF DESCRIPTION OF THE DRAWINGS

FIG. 1 is a block diagram of a system that may facilitate access to, and analysis of, business information according to some embodiments.

FIG. 2 is a flow diagram of process steps pursuant to some embodiments.

FIG. 3 illustrates an example of source and result data elements according to some embodiments.

FIG. 4 is a flow diagram of process steps pursuant to some other embodiments.

FIG. 5 is a block diagram of a system that may facilitate a user's transfer of information from selected source data elements to result data elements according to some embodiments.

FIG. 6 illustrates an example of time dependent transfer formulas according to some embodiments.

FIG. 7 illustrates an example of a business integration source and result database according to some embodiments.

### DETAILED DESCRIPTION

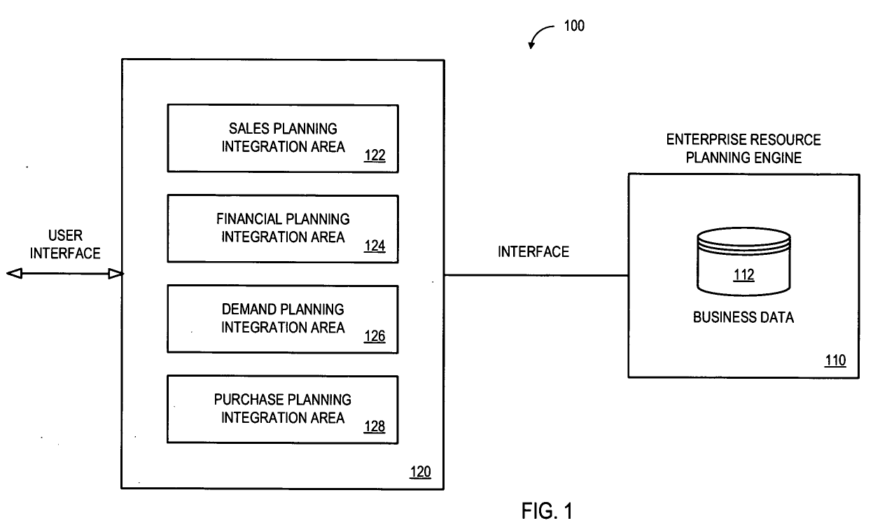

To alleviate problems inherent in the prior art, some embodiments of the present invention introduce systems, methods, computer program code and means to facilitate an automatic transfer of information from selected source data elements of one planning integration area to result data elements of another planning integration area. For example, FIG. 1 is a block diagram of a system 100 that may facilitate access to, and analysis of, business information according to some embodiments.

The system 100 includes an enterprise resource planning engine 110. The enterprise resource planning engine 110 might, for example, provide customer relationship management services, supply chain management services, e-procurement functions, business intelligence, product lifecycle information, and/or financial and marketplace analysis. The enterprise resource planning engine 110 may also store business data 112, such as current product order information.

The enterprise resource planning engine 110 may communicate with planning integration areas 120 via an interface (e.g., a local interface connection or a communication network interface). Note that elements described herein as communicating with one another may be directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more transmission protocols that are or become known, such as Asynchronous Transfer Mode (ATM), Internet Protocol (IP), Hypertext Transfer Protocol (HTTP) and Wireless Application Protocol (WAP).

As used herein, the phrase “planning integration area” might refer to, for example, business-related information or applications that can be accessed and/or analyzed by a user. In some cases, a user interface (e.g., a web portal) may be provided to let a user communicate with one or more planning integration areas 120. For example, a sales planning integration area 122 might include information to help a user predict and track product sales (including sales opportunities, contracts, orders, and/or quotations) based on business data 112 stored at the enterprise resource planning engine 110.

As another example, a financial planning integration area 124 might predict and track cost, revenue, and/or profit information associated with products or services available from an enterprise. Other examples might include a demand planning integration area 126 and/or a purchase planning integration area 127. Although specific examples of planning integration areas 120 are described herein, note that embodiments may be practiced with any other type of business planning integration areas.

In some cases, a user might want to exchange information between planning integration areas 120. For example, current and/or predicted sales information from the sales planning integration area 122 might be useful when generating and/or updating a profitability plan associated with the financial planning integration area 120. Manually entering or copying information between the planning integration areas 120 could be a time-consuming and error-prone process.

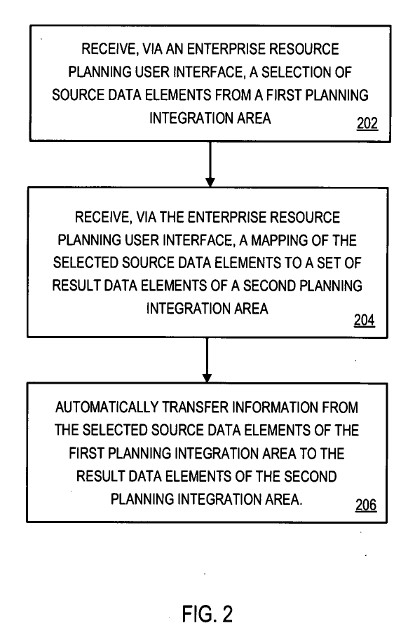

FIG. 2 is a flow diagram of process steps that might be associated with the system 100 of FIG. 1 pursuant to some embodiments. The flow charts described herein do not necessarily imply a fixed order to the actions, and embodiments may be performed in any order that is practicable. Note that any of the methods described herein may be performed by hardware, software (including microcode), firmware, or any combination of these approaches. For example, a storage medium may store thereon instructions that when executed by a machine result in performance according to any of the embodiments described herein.

At 202, a selection of source data elements may be received via an enterprise resource planning user interface. By way of example, a selection of one or more source data elements might be received via a Graphical User Interface (GUI) associated with an enterprise resource planning system. The selection of source data elements might be associated with, for example, a first planning integration area (e.g., a sales planning integration area).

At 204, a mapping of the selected source data elements to a set of result data elements may be received via the enterprise resource planning user interface. The mapping of data elements may be associated with a “pattern” or template that defines how one or more source data elements relate to one or more result data elements.

The result data elements may be associated with a second planning integration area. For example, when the source data elements are associated with a sales planning integration area, the result data elements might be associated with a financial, demand, purchase, or procurement planning integration area. Note that the first and second planning integration areas could be the same type of area (e.g., a first planning integration area could be associated with one time period while a second planning area of the same type is associated with a different time period). For example, the source data elements might be associated with a 2008 sales planning integration area while the result data elements are associated with a 2009 sales planning integration area.

At 206, information may be automatically transferred from the selected source data elements of the first planning integration area to the result data elements of the second planning integration area. For example, data values from a sales planning integration area might be transferred to a demand planning integration area.

In some cases, a transfer of information between areas is performed in accordance with a data transfer formula. For example, a source data value might be multiplied by a pre-determined constant before being transferred to a result data value. Moreover, according to some embodiments, source data elements are associated with a plurality of products (or product groups), and different products (or groups) are associated with different data transfer formulas. For example, a source data value for a first product might be multiplied by “0.95” while a source data value for a second product is multiplied by “1.05” before being transferred to their respective result data values. Note that a single result data element could be based, at least in part, on multiple selected source data elements. For example, a first source data element value might be added to a second source data element value before being transferred to a result data element.

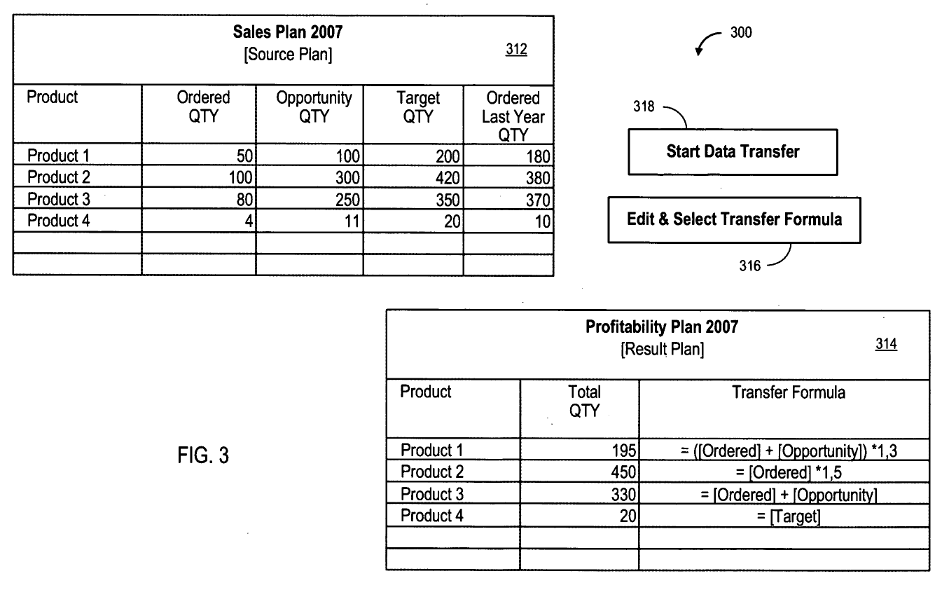

FIG. 3 illustrates a GUI example 300 of source and result data elements according to some embodiments. In particular, a sales planning integration area 312 (the “Sales Plan 2007”) may be used to select one or more source data elements. The source data elements might include, for example, a product identifier and a current ordered products quantity (e.g., a total number of products that have actually been ordered by customers). Other source data elements might include a quantity associated with products in an opportunity pipeline, a total sales target quantity (e.g., a “sales target” assigned to a sales team), and/or a historical ordered products quantity (e.g., how many products were ordered last year).

The example 300 also includes a financial planning integration area 314 (the “Profitability Plan 2007”) that may be used to select one or more result data elements. In particular, a user may map, on a product-by-product basis, source data elements from the sales planning integration area 312 to a total quantity in the financial planning integration area 314. The financial planning integration area 314 further includes an indication of transfer formulas that may be used to transfer values. A user might, for example, select an “edit and select transfer formula” icon 316 to designate source and/or result data elements and/or to define or modify transfer formulas. The user may then, when the displayed total quantity results seem appropriate, select a “start data transfer” icon 318 to transfer the values from the sales planning integration area 312 to the financial planning integration area 314.

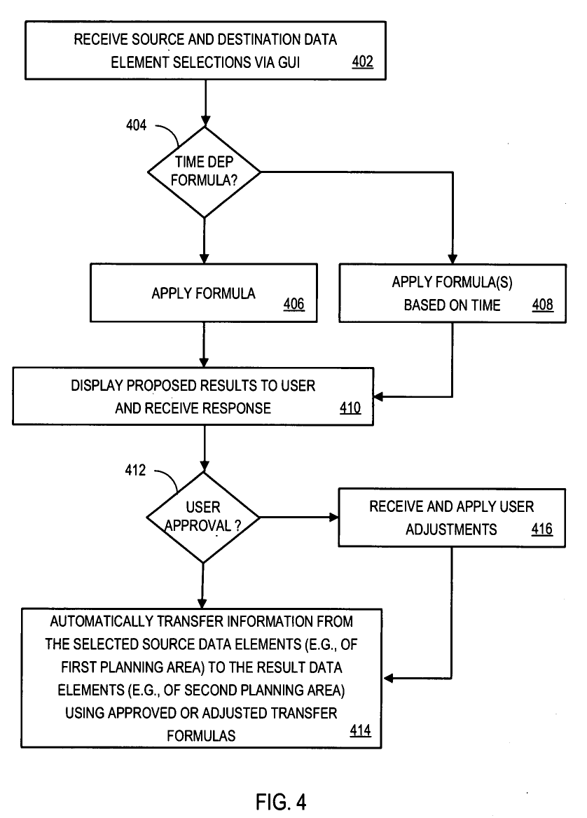

FIG. 4 is a flow diagram of process steps pursuant to some other embodiments. At 402, source and destination data element selections are received via a GUI. For example, a user might select a set of source data elements and define a formula to be used when mapping those elements to one or more result data elements.

According to some embodiments, a plurality of data transfer formulas are associated with a single product, and each data transfer formula is associated with a different time period. For example, a first transfer formula might be used to transfer values associated with the current year while another formula is to be used when transferring values associated with future years.

If the transfer formulas are not time dependent at 404, the formulas are simply applied for each product and/or source data element at 406 before proposed results are displayed to a user at 410. If the transfer formulas are time dependent at 404, the formulas are instead applied based on applicable time periods before the proposed results are provided at 410.

A user might then indicate that the proposed results are appropriate at 412. If so, information from the selected source data elements (e.g., of a first planning area) can then be automatically transferred to result data elements (e.g., of a second planning area) using the approved transfer formulas at 414. If the user instead indicates that the proposed results are not appropriate at 412, he or may provide adjustments at 416. For example, the user might adjust a transfer formula, which source elements are to used in a formula, and/or an actual result value itself (e.g., to manually over-ride a transfer formula). Based on the adjustments, information from the selected source data elements can then be automatically transferred to result data elements at 414.

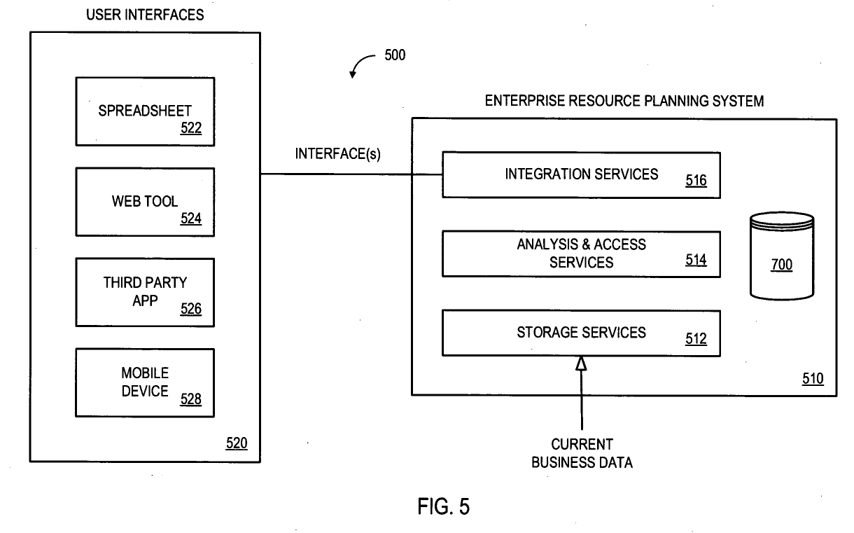

FIG. 5 is a block diagram of a system 500 that may facilitate a user's transfer of information from selected source data elements to result data elements according to some embodiments. In particular, an enterprise resource planning system 510 may exchange information via one or more user interfaces 520. Note that the enterprise resource planning system 510 (as well as the other systems described herein) may use processor-executable program code read from one or more of a computer-readable medium, such as a floppy disk, a CD-ROM, a DVD-ROM, a magnetic tape, and a signal encoding the process, and then stored in a compressed, uncompiled and/or encrypted format. Note that embodiments are not limited to any specific combination of hardware and software.

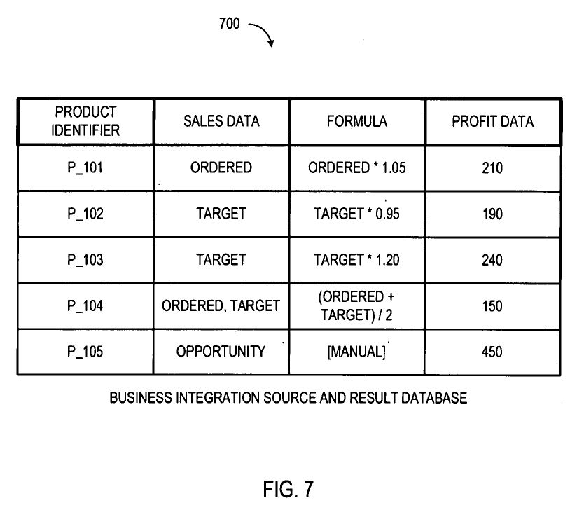

The enterprise resource planning system 510 may include storage services 512 to receive current business data and to store information in a database 700 (a simple example of which is described with respect to FIG. 7). Analysis and access services 514 may then access the database 700 (e.g., to generate business reports and messages for various users). Note that the enterprise resources planning system 510 and associated components might, for example, support any of the protocols in the following non-exhaustive list: Java Database Connectivity (JDBC), Java Connector (JCO), P4, and Simple Object Access Protocol (SOAP). Moreover, the database 700 might comprise a relational database accessible via a Structured Query Language (SQL) interface and/or systems which provide intermediary “business intelligence” to data stored within the database 700.

The enterprise resource planning system 510 may further include integration services 516 according to any of the embodiments described herein. For example, the integration services 516 might receive, via the user interfaces 520, a selection of source data elements from a first area along with a mapping of the selected source data elements to a set of result data elements of a second area. The integration services 516 might further facilitate an automatic transfer of information, in accordance with at least one data transfer formula, from the selected source data elements to the result data elements.

The user interfaces 520 might include, for example, a spreadsheet 522 and or a web tool 524. By way of example, the web tool 524 might be associated with a web browsing application that transmits a HyperText Transfer Protocol (HTTP) request for a particular web page. The request might be received by the enterprise resource planning system 510 (acting as a web server) which responds to the request by transmitting HyperText Markup Language (HTML) data and/or associated JavaScript code. For example, the web browsing application may render a display such as the one illustrated in FIG. 3 by executing JavaScript code that lets the web tool 524 dynamically retrieve and display data.

Other examples of user interfaces 520 might include, for example, a third-party application 526 and/or a “mobile” device 528, such as a laptop computer, a Personal Digital Assistant (PDA), a tablet computer, a handheld computer, a cellular telephone, a dedicated mobile device, and any other suitable mobile device or devices that are or become known.

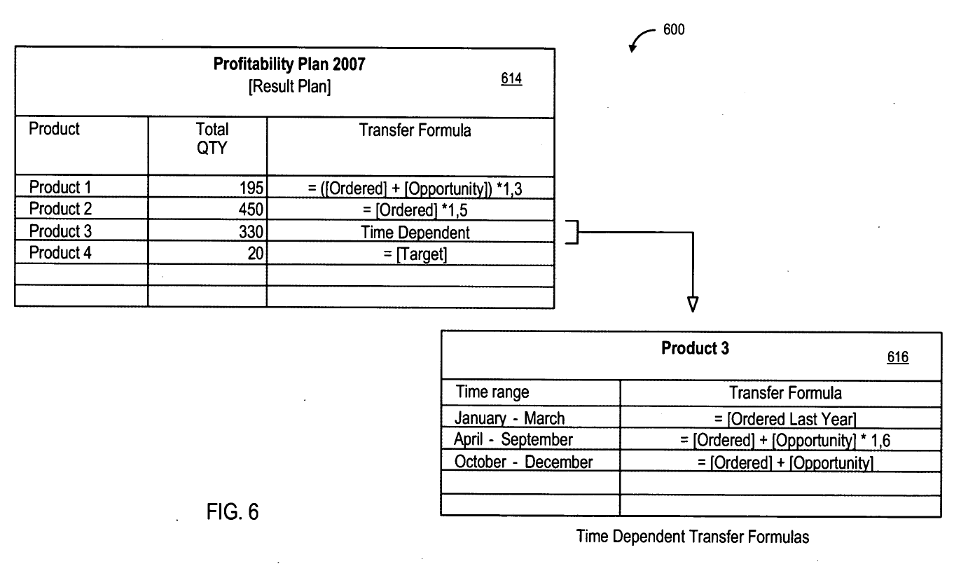

According to some embodiments, a number of different data transfer formulas are associated with a single product, and each of the data transfer formulas are associated with a different time period. By way of example, FIG. 6 illustrates an example 600 of time dependent transfer formulas 616 according to some embodiments. In particular, a total quantity result data element (of a financial planning integration area 614) associated with “Product 3” is mapped to a number of different time dependent transfer formulas 616. That is, for the time period beginning January 2007 and ending March 2007 the total quantity result data element should be calculated as being equal to an “Ordered Last Year” source data element. From April 2007 through September 2007, on the other hand, the total quantity result data element should be calculated as an “Ordered” source data element added to an “Opportunity” source data element multiplied by “1.6.”

FIG. 7 illustrates one example of a business integration source and result database 700 according to some embodiments. Note that the database 700 is merely provided as any other types of information might be stored in any number of different ways. The database 700 includes a number of product identifiers, such as unique alphanumeric identifiers associated with products or services available from an enterprise. Each product identifier may be associated with sales data values (e.g., one or more source data elements), formulas (e.g., time independent or time dependent transfer algorithms), and/or profit data values (e.g., one or more result data elements). Moreover, the sales data information might be automatically transferred to the profit data information in accordance with any of the embodiments described herein. Note that the database 700 could also be store information to let a user keep track of how and why information was copied between integration areas.

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

For example, although embodiments have been described as mapping information from a first integration planning area to a second planning area, embodiments might also map the selected source data elements to result data elements in a third area. For example, sales data might be automatically transferred to both a financial planning area and a purchase planning area. Similarly, source data elements from a number of different integration planning areas could be simultaneously be used to generate result values in one or more other areas. For example, both sales data and demand data could be used to generate a result that is transferred to a financial planning integration area.

The several embodiments described herein are solely for the purpose of illustration. Persons skilled in the art will recognize from this description other embodiments may be practiced with modifications and alterations limited only by the claims.

What is claimed is:

1. An integrated business planning method, comprising:
receiving, via an enterprise resource planning user interface, a selection of source data elements from a first planning integration area;
receiving, via the enterprise resource planning user interface, a mapping of the selected source data elements to a set of result data elements of a second planning integration area; and
automatically transferring information from the selected source data elements of the first planning integration area to the result data elements of the second planning integration area.

2. The method of claim 1, wherein the automatic transfer of information is performed in accordance with a data transfer formula.

3. The method of claim 2, wherein source data elements are associated with a plurality of products and different products are associated with different data transfer formulas.

4. The method of claim 2, wherein a plurality of data transfer formulas are associated with a single product, each data transfer formula being associated with a different time period.

5. The method of claim 1, wherein the first planning integration area comprises a sales planning integration area for a first time period and the second planning integration area comprises a sales planning integration area for a second time period.

6. The method of claim 1, wherein at least one of the first or second planning integration areas is associated with at least one of: (i) sales planning, (ii) financial planning, (iii) demand planning, or (iv) purchase planning.

7. The method of claim 1, further comprising:
displaying to a user a proposed result value.

8. The method of claim 7, further comprising:
receiving from the user an approval of the proposed result value.

9. The method of claim 7, further comprising:
receiving from the user an adjustment to the proposed result value.

10. The method of claim 1, further comprising:
displaying to a user a proposed data transfer formula.

11. The method of claim 10, further comprising:
receiving from the user an approval of the proposed data transfer formula.

12. The method of claim 10, further comprising:
receiving from the user an adjustment to the proposed data transfer formula.

13. The method of claim 1, wherein the enterprise resource planning user interface comprises a graphical user interface.

14. The method of claim 1, wherein the first planning integration area comprises a sales planning integration area and at least one of the selected source data elements is associated with at least one of: (i) a product identifier, (ii) a current ordered products quantity, (iii) a quantity associated with products in an opportunity pipeline, (iv) a total sales target quantity, or (v) a historical ordered products quantity.

15. The method of claim 1, wherein a single result data element is based at least in part on multiple selected source data elements.

16. The method of claim 1, further comprising:
receiving, via the enterprise resource planning user interface, a mapping of the selected source data elements to another set of result data elements of a third planning integration area; and
automatically transferring information from the selected source data elements of the first planning integration area to the result data elements of the third planning integration area.

17. An apparatus, comprising:
an enterprise resource planning system to store current business data; and
a planning integration system to (i) receive, via a user interface, a selection of source data elements from a first area, (ii) receive, via the user interface, a mapping of the selected source data elements to a set of result data elements of a second area, and (iii) automatically transfer information, in accordance with at least one data transfer formula, from the selected source data elements to the result data elements.

18. The apparatus of claim 17, wherein the user interface is associated with at least one of: (i) a spreadsheet, (ii) a web tool, (iii) a third-party application, or (iv) a mobile device.

19. The apparatus of claim 17, wherein the enterprise resource planning system includes at least one of: (i) analysis and access services, or (ii) storage services.

20. A computer-readable medium storing processor-executable process steps, the process steps comprising:
receiving, via an enterprise resource planning user interface, a selection of source data elements from a first planning integration area;
receiving, via the enterprise resource planning user interface, a mapping of the selected source data elements to a set of result data elements of a second planning integration area; and
automatically transferring information, in accordance with a data transfer formula, from the selected source data elements of the first planning integration area to the result data elements of the second planning integration area.

21. The computer-readable medium of claim 20, wherein source data elements are associated with a plurality of products and different products are associated with different data transfer formulas.

22. The computer-readable medium of claim 20, wherein a plurality of data transfer formulas are associated with a single product, each data transfer formula being associated with a different time period.
